(19) United States
(12) Patent Application Publication
(10) Pub. No.: US 2015/0088490 A1
(43) Pub. Date: Mar. 26, 2015

(54) SYSTEM AND METHOD FOR CONTEXT BASED KNOWLEDGE RETRIEVAL

(71) Applicant: Interactive Intelligence, Inc., Indianapolis, IN (US)

(72) Inventor: Joseph A. Behymer, Indianapolis, IN (US)

(73) Assignee: Interactive Intelligence, Inc., Indianapolis, IN (US)

(21) Appl. No.: 14/037,837

(22) Filed: Sep. 26, 2013

(51) Int. Cl. G06F 17/27; G06N 5/02

(52) U.S. Cl. CPC G06F 17/2765; G06F 17/2705; G06N 5/022
USPC 704/9

(57) ABSTRACT

A system and method are presented for context based knowledge retrieval. In one embodiment, such retrieval pertains to pattern recognition for data related to interactions between users, configuration and organization of systems data in an enterprise, and the quality of calculations of communication interactions. In one embodiment, a communication may be analyzed and a user interface created of potential sources of information related to the communication. This information may be from an internal source, such as a knowledge base, or an external source, such as an internet connected information source, for example. The user interface may comprise entities with associated links and actions, which may be configured based on a user's preference.

### BACKGROUND

The present invention generally relates to telecommunications systems and methods. More particularly, the present invention pertains to pattern recognition and actions based on context within interactions.

### SUMMARY

A system and method are presented for context based knowledge retrieval. In one embodiment, such retrieval pertains to pattern recognition for data related to interactions between users, configuration and organization of systems data in an enterprise, and the quality of calculations of communication interactions. In one embodiment, a communication may be analyzed and a user interface created of potential sources of information related to the communication. This information may be from an internal source, such as a knowledge base, or an external source, such as an internet connected information source, for example. The user interface may comprise entities with associated links and actions, which may be configured based on a user's preference.

In one embodiment, a system for context based knowledge retrieval is disclosed, comprising: means for determining a confidence rating of an interaction; means for evaluating context of said interaction; means for storing information; means for configuring the system; means for displaying a mapping of a communication; and, means for reporting results.

In another embodiment, A system for context based knowledge retrieval is disclosed, comprising: means for parsing an interaction between two or more users; means for spotting configured keywords in said interaction; means for evaluating said keywords and determining a confidence rating on said keyword spotting accuracy; means for determining a context of said keywords; means for presenting said keywords to a user; means for linking said keywords to other keywords previously recognized in said interaction; means for presenting actions associated to said keywords; means for storing information; means for configuring the system; and, means for reporting on stored information.

In another embodiment, a method for context based knowledge retrieval is disclosed, comprising the steps of: recognizing data; interpreting data; adding nodes to a call view map representing said data; adding links to said nodes; and, adding actions to said nodes.

### BRIEF DESCRIPTION OF THE DRAWINGS

FIG. 1 is a diagram illustrating an embodiment of a system.

FIG. 2 is a flowchart illustrating one embodiment of a process for determining relevant information.

FIG. 3 is a diagram illustrating an embodiment of a call map.

FIG. 4 is a diagram illustrating an embodiment of a user interface.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Interactions may require actions based on their context. Advanced interactive voice response (IVR) systems have historically tried to take advantage of this, but systems can be improved upon to automatically make connections and inform a user based on the knowledge sources an organization may have in place.

For example, the context information within the system may depend upon knowledge of the organization, including a customer relationship management (CRM) system, a support ticket system, a human resources (HR) database, as well as any other sources that may be specific to an organization, or otherwise specified. In the technical support field, for example, clients may be asked for their model number when the contact support. When the model number is given, it could be looked up in a database and relevant information for that model could be presented to the agent. The system may then present actions that the agent could take after retrieving such information from a client. For example, the system may allow the agent to find troubleshooting information for that model, view statistics on the common types of problems with the model, or simply report to another database that the client is having an issue with this particular model. In at least one embodiment, the system may also relay a confidence score for a keyword spotting result. In such an embodiment, the system should be able to employ probabilistic logic on the context of the information and any related systems to identify the confidence level of the result.

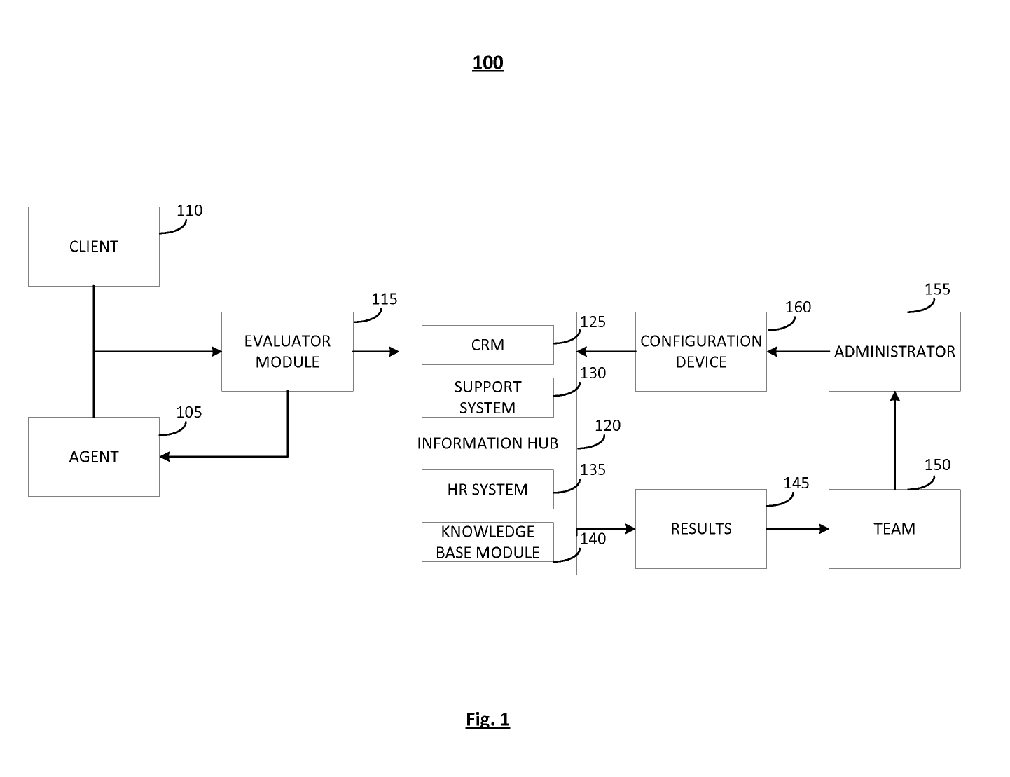

FIG. 1 is a diagram illustrating the basic components in an embodiment of a system for context based knowledge retrieval, indicated generally at 100. The basic components of a context based knowledge retrieval system 100 may include: an agent 105; a client 110; an evaluator module 115; an information hub 120 which may include a CRM module 125, a support system module 130, an HR system module 135, and a knowledge base module 140; results 145; a team 150; an administrator 155; and a configuration device 160.

The Agent 105 may comprise an agent working in a contact center, such as a call center, for example. The agent may have access to a display environment upon which interactions are displayed. The Client 110 may interact with the Agent 105. In one embodiment, a client may comprise a customer or a person calling in on a personal communication device, such as a cellular telephone for example. This interaction may be evaluated by the Evaluator Module 115. The Evaluator Module 115 may perform evaluation in real time to determine the confidence and context of the Client 110 interaction with the Agent 105. In an embodiment, the Evaluator Module 115 may be used to configure interactions in a communication, such as a communication using a cellular telephone. The communication may be evaluated by the module 115 and relevant actions presented to an agent based on the interaction and the configured entities, systems, and actions in the module 115. In one embodiment, keyword spotting may be used to detect relevant information during the interaction between the Agent 105 and the Client 110. For example, when a client identifies information, such as their street address, the address would be recognized and an associated entity may appear in the display for an agent. Confidence metrics may be used to determine a confidence score for each result. In at least one embodiment, the confidence score may be related to the agent's productivity, such as highlighting results the system has more confidence in.

Relevant system information may exist within the Information Hub 120. Such information may be evaluated by the Evaluator Module 115 based on configuration and criteria set up by an Administrator 155 in the Configuration Device 160. The evaluator module may also extract context from an interaction between a customer and an agent and present this information back to the agent. The Information Hub 120 may contain modules or resources that are specific to an organization utilizing the system or otherwise specified. Such information may be utilized during keyword spotting based on configuration from the Configuration Device 160. In the example illustrated, a CRM module 125, a support system module 130, an HR system module 135, and a knowledge base module 140 are shown. It should be noted that these are shown for illustration purposes and that it is within the scope of this disclosure to include any number or type of modules or resources. A CRM module 125 may include collaboration software, such as Microsoft Corporation's SharePoint. Information may be retrieved from this module. A support system module 130 may include information such as support tickets that have been opened by customers. Information may also be retrieved from this module. An HR system module 135 may contain information about a company, such as their employees and related information. Information may also be retrieved from this module. A Knowledge base module 140 may comprise team collaboration software, such as Altassian's Confluence. This module may also comprise an other type of internal information system or internal database. Alternatively, the knowledge base module 140 may also comprise external information sources such as a source with an external application programing interface (API), or an internet/intranet connected information source such as a website. The Information Hub 120 may contain information that depends on the knowledge of the organization and other specific sources. The system should be able to understand and categorize relevant information from many different systems.

The results 145 may include confidence results tracked by the system. Results may also include information that is shown to the agent or other users of the system, such as an administrator, and other relevant information that a team 150 may use during review. Such information may include interaction length between an agent and a customer or which entities were used. The results may allow a user of the system to alter the system to achieve the desired quality of results. Changes may be made by the team 150 to the configuration of the system based on the results 145. A team 150 may make suggestions to an administrator 155 about the system. In at least one embodiment, a team may not be needed. An administrator may perform result evaluation and configuration updates instead of a team.

An administrator 155 may be a person who has access to the configuration device and makes changes to the configuration containing entities, links, and actions in order to improve customer service levels. For example, an administrator would be able to use the configuration device to decide how the information in a database may be formatted, such as a support ticket number or other reference number. Other information may be learned, such as what actions an agent may take on a reference number when it is mentioned in a conversation with a customer. Such actions may comprise opening an account, viewing a list of items, etc.

A configuration device 160 may use entities, links, and actions to configure the system. An entity may be the objects of the business. Entities may comprise nouns, such as people, places and things that an organization cares about. Entities may also comprise identifiers used to represent objects in the business, such as a support ticket identification number or a serial number. Entities may have links between them and various actions that are supported against them. Entities, links and actions may be configured by an organization to be compatible with the operation of the organization system. An action may comprise an available option to act on an entity when it appears in an interaction between a client and an agent. Examples of actions may include, but not be limited to the following examples: opening a webpage with a customer's order information, updating a support item based on information from a customer, or adding a calendar item to a member of the organization. Links may allow entities to be associated with each other and may be used to judge the confidence that an entity was mentioned in a conversation. Some examples of links may include, but not be limited to: items purchased together, a doctor having an appointment with a patient, or a salesman who sold to a certain customer.

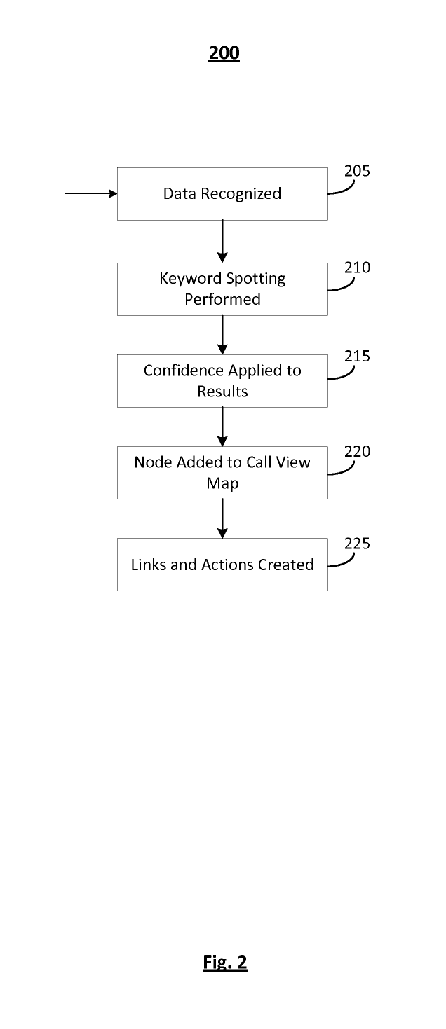

As illustrated in FIG. 2, one embodiment of a process 200 for determining relevant information is provided. The relevant information may be extracted from an interaction between a client and an agent. The process 200 may be operative in the evaluator module 115 of the system 100 (FIG. 1). The process 200 may occur in a cycle.

In operation 205, data is recognized. For example, data such as words and/or symbols may be tokenized from a stream of audio or text. Control is passed to operation 210 and process 200 continues.

In operation 210, data is interpreted. For example, keyword spotting may be performed on the data such that certain configured tokens in the configuration device are searched for. Control is passed to operation 215 and the process 200 continues.

In operation 215, a confidence value may be applied to the results of data recognition. A confidence may be applied to a keyword such that recognized text has a confidence value confirming it is the desired text. Confidence values may be set based on preference. Control is passed to operation 220 and process 200 continues.

In operation 220, a node is added to the map. For example, a node may be added to a call view map that allows a system user (i.e., agent or other system operator) to perform actions on the data. Control is passed to operation 225 and the process 200 continues.

In operation 225, links may be created between nodes. Such links may be created between nodes, or entities, which may be people involved, such as a customer, a salesman, etc. The links may allow a system user to perform actions on the data, such as update, view, print, etc. Control is passed back to operation 205 and process 200 continues.

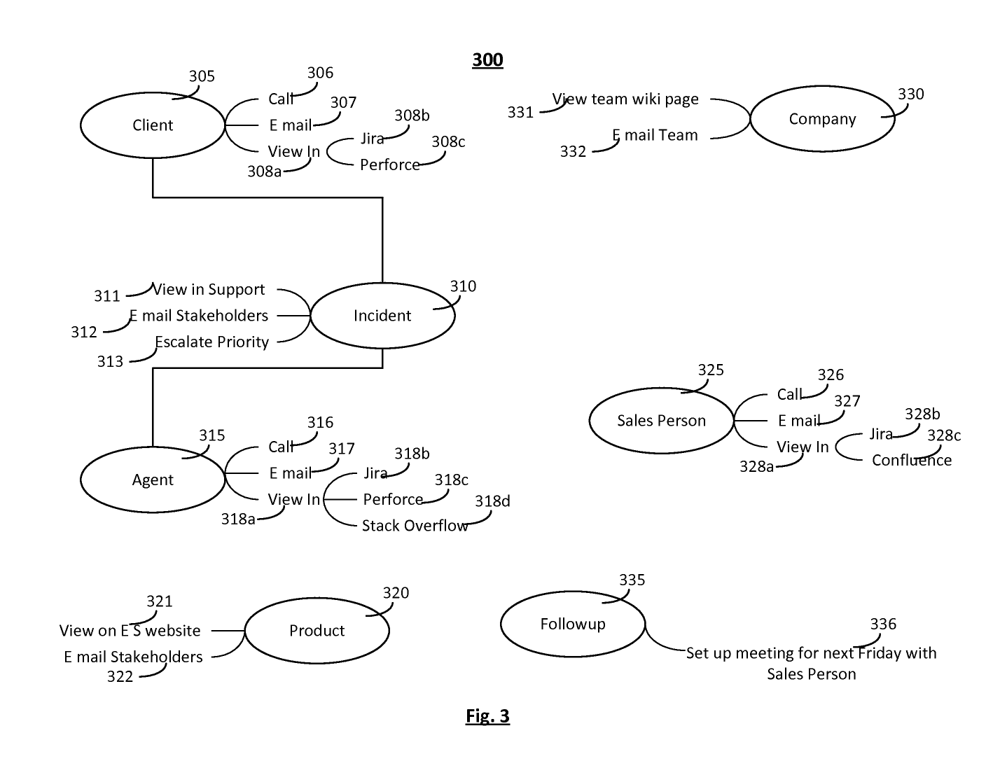

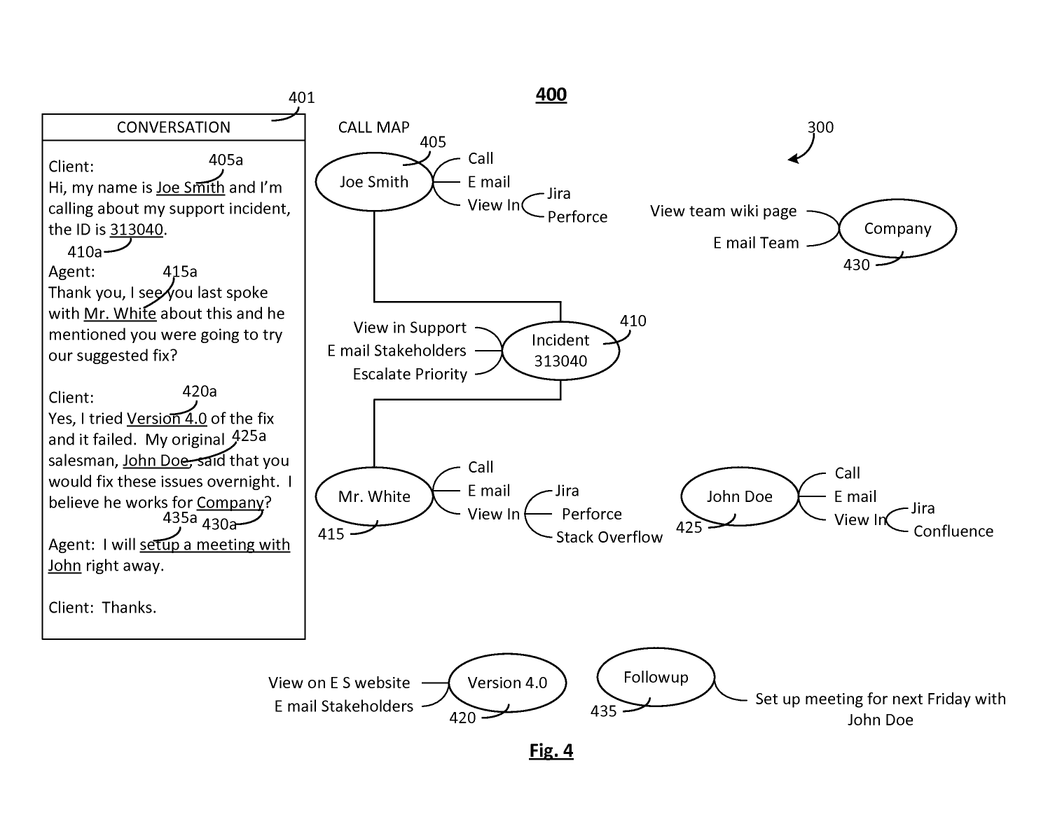

FIG. 3 is a diagram illustrating the basic components in an embodiment of a call map, indicated generally at 300. The call map may be based on a conversation that has occurred, or is occurring, such as explained in greater detail in FIG. 4 below.

In FIG. 3, the entity Client 305 may have associated actions, such as call 306, E-mail 307, and View In 308a. These actions may be organizational specific and are not limited to those described in the following examples. Selecting the action call 306 may initiate a call to the client, for example. Actions may also have additional actions associated with them. For example, the action View In 308a has the further actions Jira 308b and Perforce 308c associated with it. Selecting either Jira 308b or Perforce 308c may allow an agent to view client information within the program selected, which in this example may be either Atlassian's Jira software or Perforce Software Inc.'s Perforce. An action may be an available option to act on an entity when it appears in an interaction. Examples of actions may include, but not be limited to the following examples: opening a webpage with a customer's order information, updating a support item based on information from a customer, or adding a calendar item to a member of the organization. The entity Client 305 may be linked to the entity Incident 310. Links may allow entities to be associated with each other and may be used to judge the confidence that an entity was mentioned in a conversation. Some examples of links may include, but not be limited to: items purchased together, a doctor having an appointment with a patient, or a salesman who sold to a certain customer.

The entity Incident 310 may have associated actions: View in Support 311, E-mail Stakeholders 312, and Escalate Priority to Code Red 313. The entity Incident 310 may be linked to the entity Agent 315. An administrator may add actions relevant to their business, such as opening a website, viewing a list of contributors, or changing the state of a task. For example, if a support ticket is received, an external application may be used to open the ticket such as Support, 311. An email may then be created to the Stakeholders 312 who are relevant, such as workers and the client. The priority of the ticket may also be escalated 313 if a matter is time sensitive or the subject matter is crucial to the business.

The entity Agent 315 may have associated actions Call 316, E-mail 317, and View In 318a. The action View In 318a has the further actions Jira 318b, Perforce 318c, and StackOverflow 318d associated with it.

The entity Product 320 may have associated actions View on E S website 321 and E-mail Stakeholders 322.

The entity Salesman 325 may have associated actions Call 326, E-mail 327, and View In 328. The action View In 328a has the further actions Jira 328b, and Confluence 328c associated with it. Selecting an action may allow an agent to e-mail, call, or otherwise contact the Salesman or view further information in an associated program such as Confluence or Jira.

The entity Company 330 may have associated actions View team wiki page 331 and E-mail Team 332. The actions may allow an agent to see Company related information available such as relevant team members who can help with the issue.

The entity Follow up 335 may have the associated action “Setup meeting for Next Friday with John Doe” 336. This may allow an agent to quickly access John Doe's calendar and schedule a time for the client to discuss their issue with John Doe.

FIG. 4 is a diagram illustrating an embodiment of a user interface indicated generally at 400. The user interface 400 may have a conversation 401 displayed alongside a call view map 300. A call map may include entities that are linked together and have actions associated with them, such as described in FIG. 3. An entity may be the objects of the business. Entities may comprise nouns such as people, places and things that an organization cares about. Entities may also be identifiers used to represent objects in the business, such as a support ticket identification number or a serial number. Entities may have links between them and various actions that are supported against them. Entities, links and actions may be configured by an organization to match how their organizational system operations.

The communication between a client and an agent may occur as follows:

Client: Hi, my name is Joe Smith and I'm calling about my support incident, the ID is 313040.

Agent: Thank you, I see you last spoke with Mr. White about this and he mentioned you were going to try our suggested fix?

Client: Yes, I tried Version 4.0 of the fix and it failed. My original salesman, John Doe, said that you guys would fix these issues overnight. I believe he words for Integrations?

Agent: I will setup a meeting with John right away.

As the conversation 401 is occurring, keyword spotting may identify certain words and display an associated node in the call view map 300. When the client states that their name is Joe Smith 405a, an associated node 405 may be created on the call map. The client may further state the incident identification number, or reference number, that they are calling about, such as 313040, 410a. This may also be recognized and an associated node 410 created. This node may be linked to the node 405. The agent may be able to recognize that, in the call view map, Mr. White 415a, spoke last with the client. A node 415 for Mr. White may be linked to the incident node 410. Other nodes may appear in the call map, such as the fix node 420 associated with the recognized keywords Version 4.0, 420a, that the client mentions. Another node 425 may be associated with the name of the sales man Jon Doe 425a, which was also recognized as well as a node 430 for the salesman associated Company 430a. An action node 435 may have been configured to appear based on the keywords that were recognized in the conversation or as previously determined The action node 435 may indicate a follow-up link with an associated action to “set up a meeting for next Friday with John Doe” based on the agent conversation.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the invention as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

1.-34. (canceled)

35. A computerized method for retrieving context based knowledge in an interactive voice response system, the method comprising:
receiving a communication at the interactive voice response system, the communication comprising an audio speech based at least in part on words spoken by a user and an agent;
identifying one or more keywords from the audio;
retrieving, from a database, a contextual information, the contextual information being based at least in part on the one or more keywords and the user; and
displaying the contextual information to the agent.

36. The method of claim 35, further comprising:
generating a confidence level for each of the one or more keywords.

37. The method of claim 36, wherein the contextual information is based at least in part on the confidence level for each of the one or more keywords.

38. The method of claim 35, further comprising:
adding a node to a contact map based at least in part on the contextual information; and
displaying the contact map to the agent.

39. The method of claim 38, further comprising:
receiving, from the agent, an interaction on the contact map; and
generating an activity based on the interaction.

40. The method of claim 39, wherein the activity is a meeting request.

41. The method of claim 39, wherein the activity is a request to open a web page, the web page displaying order information related to the user.

42. The method of claim 38, wherein the contact map further comprises a plurality of contact nodes.

43. The method of claim 42, further comprising:
linking the node to one or more contact nodes in the plurality of contact nodes based on the contextual information.

44. An interactive voice response system for retrieving context based knowledge, the system comprising:
an agent device;
a client device, the client device being operated by a user;
an interaction module, the interaction module storing information related to the user; and
an evaluator module, the evaluator module being configured to identify one or more keywords from audio in a communication between the client device and the agent device, retrieve the information from the interaction module based at least in part on the one or more keywords, and transmit the information to the agent device.

45. The system of claim 44, wherein the interaction module is a CRM.

46. The system of claim 44, wherein the interaction module is a support system and the information is related to one or more support tickets.

47. The system of claim 44, wherein the information is human resources data.

48. The system of claim 44, wherein the interaction module is remote from the interactive voice response system and the evaluator module is further configured to retrieve the information through an application programming interface made available on the interaction module.

49. The system of claim 44, wherein the evaluator module is further configured to generate a confidence level for each of the one or more keywords, the confidence level being a likelihood that the one or more keywords accurately reflects the audio.

50. The system of claim 44, wherein the evaluator module is configured to identify the one or more keywords based on context.

51. The system of claim 44, wherein the evaluator module is further configured to receive an interaction from the agent device based on the information.

52. A computerized method for retrieving context based knowledge, the method comprising:
identifying a plurality of keywords in a communication between an agent and a user;
generating a plurality of confidence levels, each of the plurality of confidence levels being associated with at least one of the plurality of keywords and a likelihood that the at least one keyword is correctly identified;
retrieving an information from a database based at least in part on each of the at least one keywords with the confidence level above a threshold, the information being related to the user;
adding a node to a contact map based on the information; and
displaying the contact map to the agent.

53. The method of claim 52, wherein each of the plurality of confidence levels is based on context of the communication.

54. The method of claim 52, further comprising:
receiving, from the agent, an interaction request related to the node; and
generating an interaction based on the interaction request.

55. The method of claim 54, wherein the interaction is a meeting request.

56. The method of claim 55, wherein the generating step includes retrieving a web page, the web page displaying purchase information to the user.
